(19) United States
(12) Patent Application Publication
(10) Pub. No.: US 2006/0074808 A1
(43) Pub. Date: Apr. 6, 2006

(54) Method and system for purchasing access to a recording

(76) Inventor: Peter V. Boesen, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/222,014

(22) Filed: Sep. 8, 2005

Related U.S. Application Data
(63) Continuation-in-part of application No. 10/842,207, filed on May 10, 2004.

(51) Int. Cl. G06Q 99/00

(52) U.S. Cl. 705/51

(57) ABSTRACT

A method for providing a phone service to a user for purchasing a recording is provided. The method includes providing a phone to the user, receiving over the phone a request to purchase a recording, determining the recording to be purchased, delivering the recording to the user and wherein the step of determining the recording to be purchased is based on at least one item from the set consisting of a satellite radio channel being listened to by the user, a satellite video channel being listed to by the user, a geographic position associated with the user, a voice recording stored on the phone, a set of images stored on the phone, a video stored on the phone.

### RELATED APPLICATIONS

This application is a continuation-in-part of, and claims priority to U.S. patent application Ser. No. 10/842,207, filed May 10, 2004, herein incorporated by reference in its entirety.

### BACKGROUND OF THE INVENTION

The present invention relates to a method and system for purchasing during or after exposure to a recording. More specifically, but without limitation, the present invention relates to providing immediate and convenient access to an audio or video recordings at or about the time of exposure to the recordings or live events.

### PROBLEMS IN THE ART

The present invention addresses a number of distinct problems in the art. The present invention should not be limited to the scope of the problems described herein.

The present invention offers a novel and immediate solution to the major problem relating to unauthorized use of copyrighted works, including unauthorized use of audio and video recordings. The invention recognizes that one of the major contributing factors to piracy of copyrighted works is that legitimate copies of such copyrighted works, or authorized access to the copyrighted works, cannot be provided in a manner that is convenient to the consumer. The present inventor has further recognized that the inconvenience in obtaining a legitimate copy of a copyrighted work can also serve to reduce the sales of the copyrighted work.

The inconvenience of obtaining a legitimate copy of a copyrighted work is present in a number of situations. Consider the use of radios in cars. Radios are typically utilized while driving the vehicle. One of the problems most often encountered is that a listener will hear music, or other audio events that they particularly enjoy, but is unaware of the creator. The listener may desire to obtain a copy of the music or audio event for their own personal listening pleasure, yet there are significant and important obstacles to doing so.

One difficulty is in identifying the very music being played by artist, and the title of such work. Sometimes this information is presented by an announcer prior to the music being played, but oftentimes not. After listening to the music, one becomes interested in purchasing the selection but usually cannot remember the artist, or title of the song because there was simply no way to easily recall this information while operating the vehicle and listening to the selection.

Even if one hears the artist and title of the song after the music has completed, one would preferably want to write this information down instead of relying upon memory, which is typically fleeting. This is problematic when driving, as it would remove the driver's concentration from the road.

A further problem is that even if one has properly noted the artist and song, there may be great difficulties in obtaining a recording of the music. Although not a major problem with popular music, there can be significant problems when the music is a lesser known jazz or classical selection that is played infrequently and not widely available at music stores, which themselves are under significant pressure and becoming harder to find.

The problems of obtaining identifying information about an audio event and purchasing a recording of the event is not confined to the use of car radios. This problem applies to any number of situations where audio, or video is being played, including when the audio is live, and a listener desires to purchase a recording of the audio or video event. What is needed is a method, apparatus, and system for purchasing an audio or video recording that is convenient to the listener.

A similar problem exists with respect to video. While watching a movie or other video event, or preview of a video event, it may be desirable to conveniently purchase the video. Although recording devices may ameliorate some of the need to do so, there are still a number of advantages to purchasing a recording as there may be special bonus footage associated with the recording that is not present in a mere transmission, and there may be advantages to having original media containing the video recording, including the additional clarity in the right to use the video recording without violation of any copyrights.

Therefore, it is a primary object, feature, or advantage of the present invention to improve upon the state of the art.

It is a further object, feature, or advantage of the present invention to provide a method, apparatus, and system for purchasing an audio recording of an audio event that is convenient to listener.

A still further object, feature, or advantage of the present invention is to provide a method, apparatus, and system for purchasing an audio or video recording of an audio or video event that encourages sales of the recording, and therefore discourages unauthorized copying.

Another object, feature, or advantage of the present invention is to provide a method, apparatus, and system for purchasing an audio or video recording of an event that allows a listener to purchase the recording of the event during, or shortly after the event associated with the audio or video.

Yet another object, feature, or advantage of the present invention to provide a method, apparatus, and system for purchasing recording of an event that does not significantly distract the driver of a motor vehicle.

It is a further object, feature, or advantage of the present invention to provide a method, apparatus, and system for purchasing an audio or video recording of an event that provides for delivery of the recording to the user.

A still further object, feature, or advantage of the present invention to provide a method, apparatus, and system for purchasing an audio or video recording that does not require the listener to take notice of the name of the artist or name of the song.

Another object, feature, or advantage of the present invention to provide a method, apparatus, and system for purchasing an audio recording that quantifies the relationship between an audio event and sales of audio recordings of the audio event.

These and/or other objects, features or advantages of the present invention will become apparent from the specification and claims that follow. These objects, features, or advantages of the present invention do not limit the invention as the present invention can provide other features and advantages in different embodiments and different contexts.

### SUMMARY OF THE INVENTION

The present invention is a method, apparatus, and system for purchasing audio events. A user who is listening to an audio event, in person, on the radio, or otherwise can select audio events to be purchased and delivered. Preferably, the purchase is initiated through pressing a buy button. The purchase transaction can occur over a two-way communication system, such as, but not limited to, a cellular telephone. The cellular telephone receives identifying information for the audio event directly, through a short range communication link, or otherwise.

According to one aspect of the invention, the audio events of interest to a user are associated with a radio. For example, the present invention provides a method that includes listening to an audio event transmitted to a radio and then pressing a button to initiate purchase of a recording of the audio event. According to another aspect of the present invention, a system for providing radio audio and for purchasing of audio recordings is disclosed. The system includes a radio receiver for playing audio, an intelligent control electrically connected to the radio receiver, a transceiver operatively connected to the intelligent control for transmitting and receiving purchase information, and a user interface operatively connected to the intelligent control adapted for receiving a buy command from a user.

According to another aspect of the invention, a method of purchasing an audio recording is disclosed. The method includes playing an audio event transmitted to a radio, receiving a purchase request from a user listening to the radio, transmitting the purchase request over a network with audio or video event identifying information, and receiving verification of the purchase over the network.

According to another aspect of the present invention, a method of selling audio or video recordings is disclosed. The method includes receiving a purchase request from a radio or digital video interface device that a user is listening to, identifying a recording to sell based on the purchase request, and completing a financial transaction with the user for the audio recording.

The present invention also provides for methods, apparatus, and system related to use of a phone in the purchase of audio recordings. In one embodiment of the present invention, a phone is adapted for purchasing access to an audio recording of audio associated with a source of audio. The phone includes a phone housing, a user interface for selecting the source of audio and initiating a purchase of the audio recording of audio associated with the source of audio, and a communications link to an ordering system for ordering access to the audio recording. Preferably the phone includes a “buy” button which can be a joystick-type button. This easily allows for tracking of the user for buying purposes.

According to another aspect of the present invention, a system for providing convenient purchase of access to a recording of audio is disclosed. The system provides for a device for producing audio to have an associated short range transceiver such as a BLUETOOTH or UWB transceiver. The short range transceiver is adapted to transmit information describing the audio for use in purchasing access to the audio without transmitting the audio itself. A phone having a second short range transceiver is in operative communication with short range transceiver of the device that produces audio. Thus, the phone can receive identifying information associated with the audio and can initiate the purchase of an audio recording.

According to another method of the present invention, the present invention provides for convenient purchase of a recording through determining at least one source of audio proximate a user, automatically receiving identifying information for the at least one source of audio or video input, and receiving a request from the user for purchase of a recording of the audio. The steps of determining and receiving may be performed by a phone.

A method for providing a phone service to a user for purchasing a recording is provided. The method includes providing a phone to the user, receiving over the phone a request to purchase a recording, determining the recording to be purchased, delivering the recording to the user and wherein the step of determining the recording to be purchased is based on at least one item from the set consisting of a satellite radio channel being listened to by the user, a satellite video channel being listed to by the user, a geographic position associated with the user, a voice recording stored on the phone, a set of images stored on the phone, a video stored on the phone.

### BRIEF DESCRIPTION OF THE DRAWINGS

FIGS. 1-2 provide a pictorial representation of one embodiment of a phone according to the present invention.

FIG. 3 provides a pictorial representation of the phone of FIGS. 1-2 with a user interface that allows the source of audio and delivery preferences to be selected.

FIG. 4 is a block diagram of one embodiment of the present invention.

FIG. 5 is a pictorial representation of another embodiment of the present invention.

FIG. 6 is a pictorial representation of another embodiment of the present invention.

FIG. 7 is a block diagram of another embodiment of the present invention.

FIG. 8 is a pictorial representation of yet another embodiment of the present invention.

FIG. 9 is a block diagram of another embodiment of the present invention.

FIG. 10 is an overview of a system of one embodiment of the present invention.

FIG. 11 is graphical representation of one embodiment of selection options according to one embodiment of the present invention.

FIG. 12 is an overview of a system of another embodiment of the present invention.

FIG. 13 illustrates one embodiment of a satellite system used in various embodiments of the present invention.

FIG. 14 illustrates one embodiment of the present invention for receiving satellite transmissions.

FIG. 15 illustrates another embodiment of the present invention for receiving satellite transmissions.

FIG. 16 illustrates one embodiment of a user interface according to the present invention.

FIG. 17 illustrates one embodiment of a system of the present invention installed on a rearview mirror of a vehicle.

FIG. 18 is a block diagram of one embodiment of the present invention.

FIG. 19 is a flow diagram according to one embodiment of the present invention.

FIG. 20 is a block diagram according to another embodiment of the present invention.

### DETAILED DESCRIPTION OF THE PREFERRED EMBODIMENT

The present invention includes a method and system for purchasing recordings of audio or video events. The present invention is described in terms of the preferred embodiments that follow. The present invention is not limited to these preferred embodiments and the claims of the patent should not be construed to be so limiting.

The present invention provides for a phone being used to collect identifying information about an audio event and to initiate a purchase of an audio recording of the audio event. The present invention contemplates that the collection of information and initiation of a purchase can be performed in any number of ways.

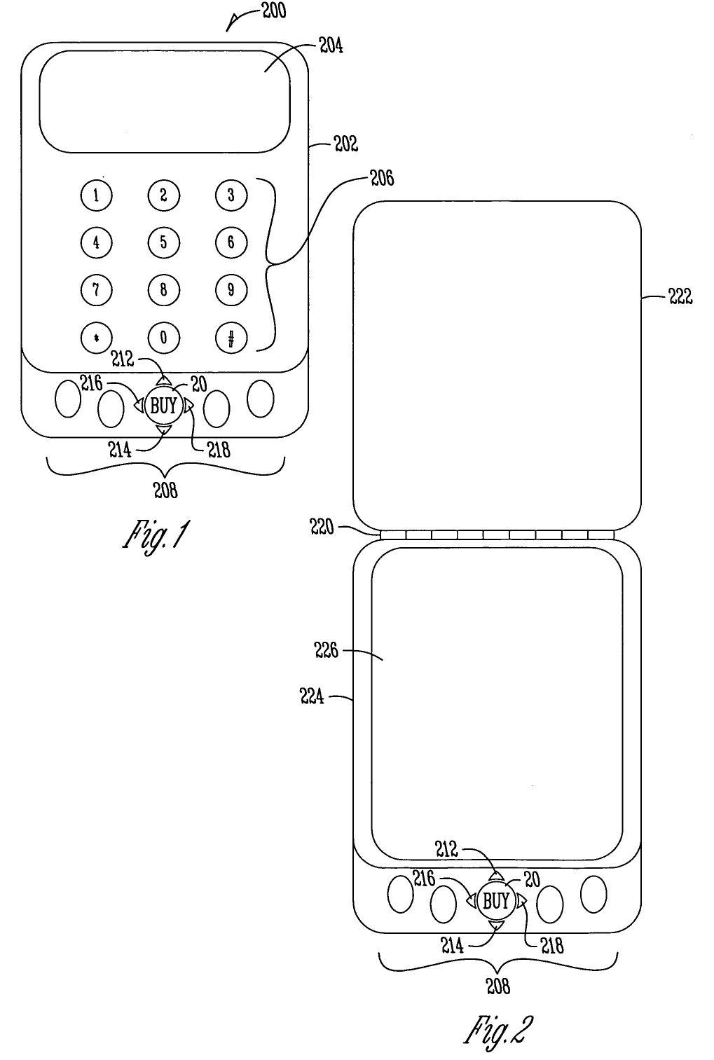

In FIG. 1, a phone 200 is shown. The phone includes a phone housing 202. The phone also includes a first display area 204. There are a plurality of buttons 206 shown, preferably configured as a dial pad. There is a second plurality of buttons 208 also shown to provide for additional functionality. This second plurality of buttons 208 preferably includes a “buy” button 20. The purpose of the buy button 20 is to initiate the purchase of an audio recording. The buy button 20 is preferably a joystick type button that allows the button 20 to be pressed upward towards top member 212, downward to bottom member 214, leftwardly to left member 216, and rightwardly to right member 218.

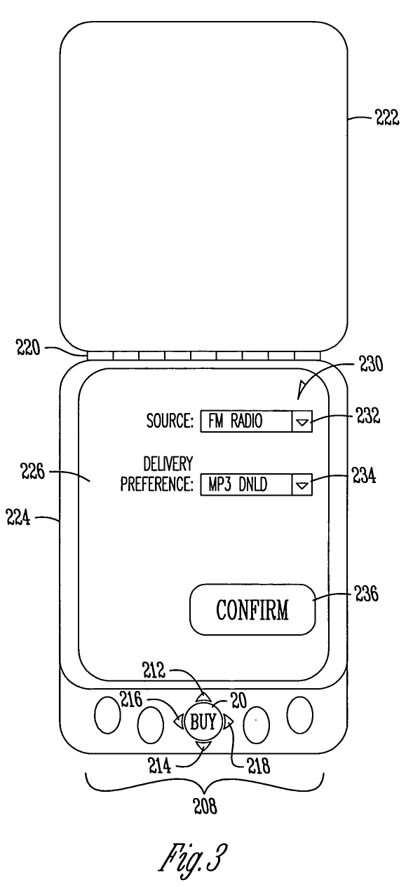

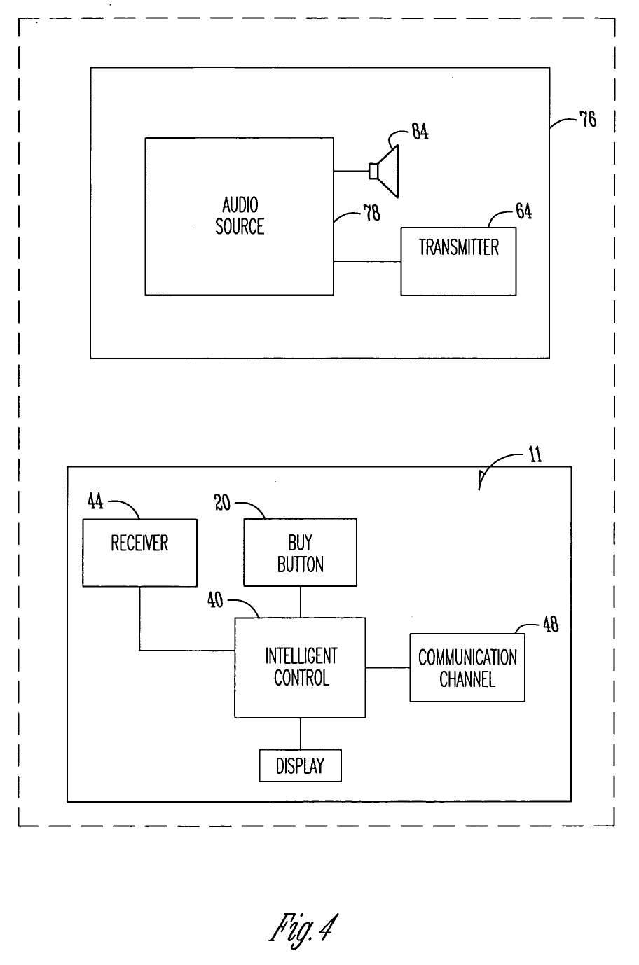

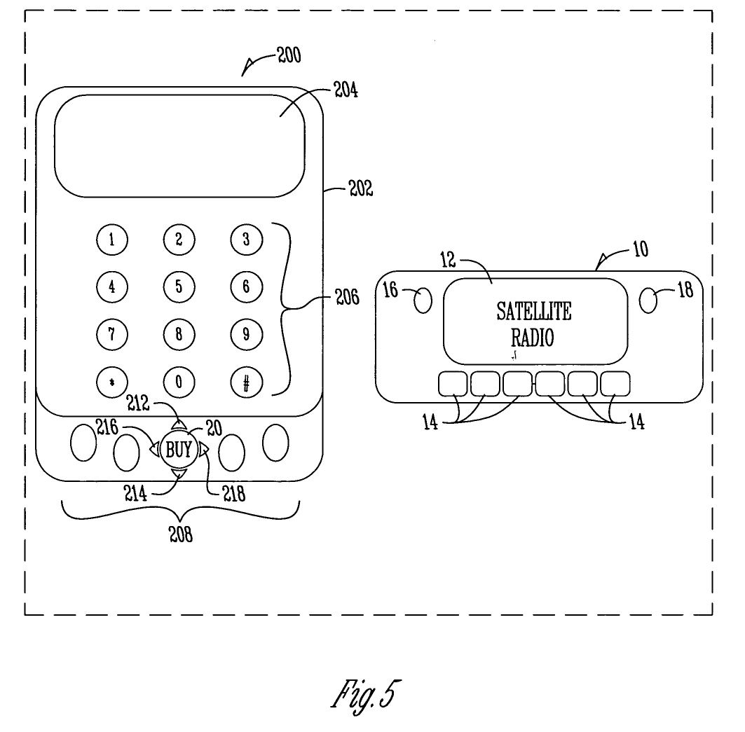

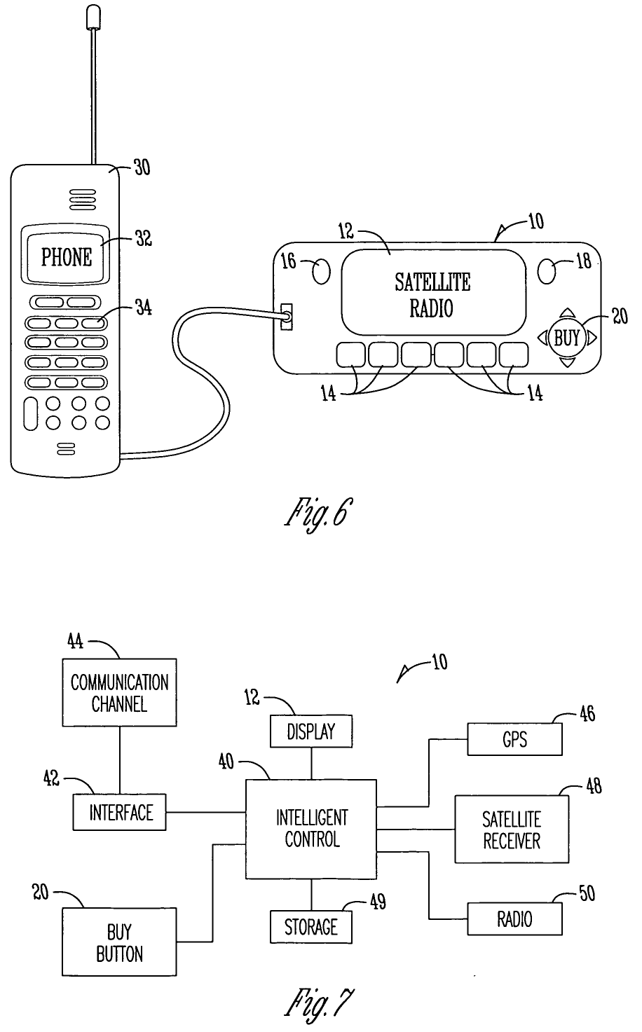

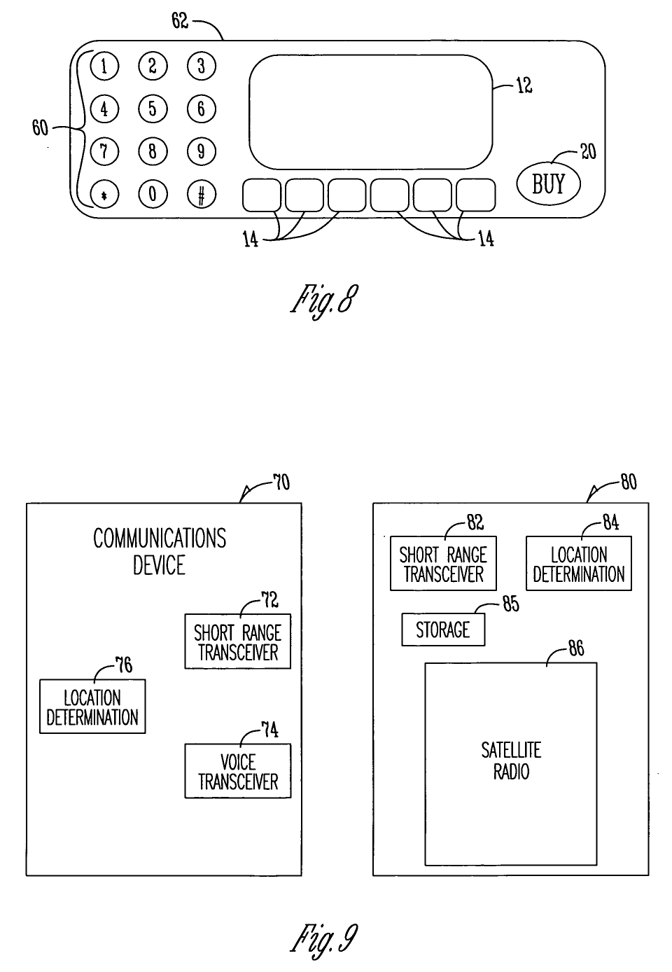

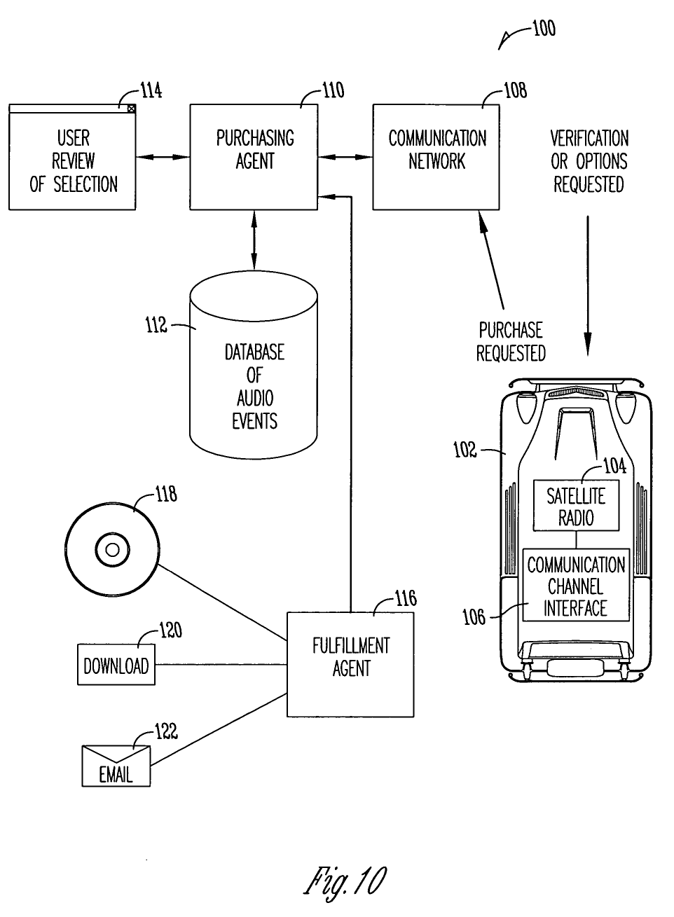

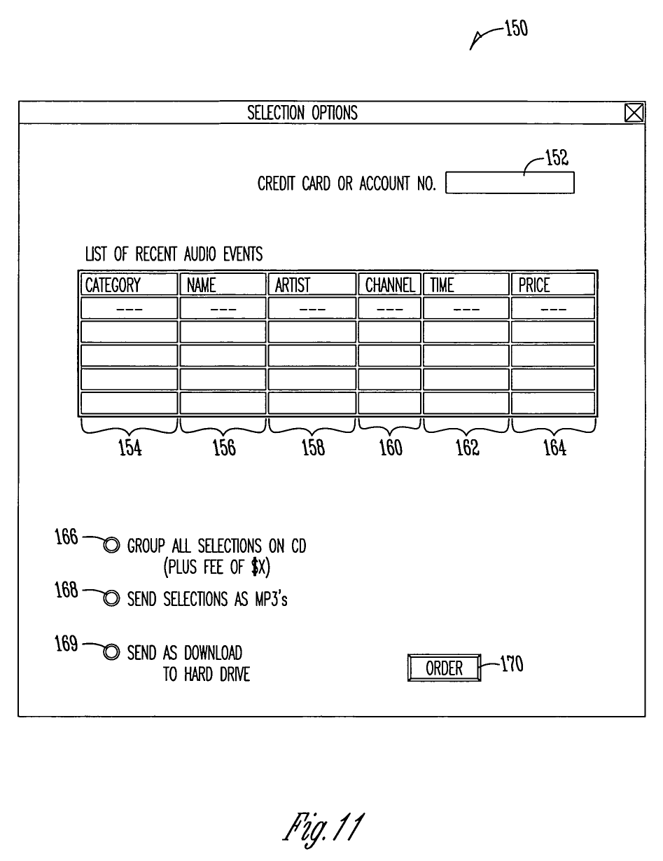

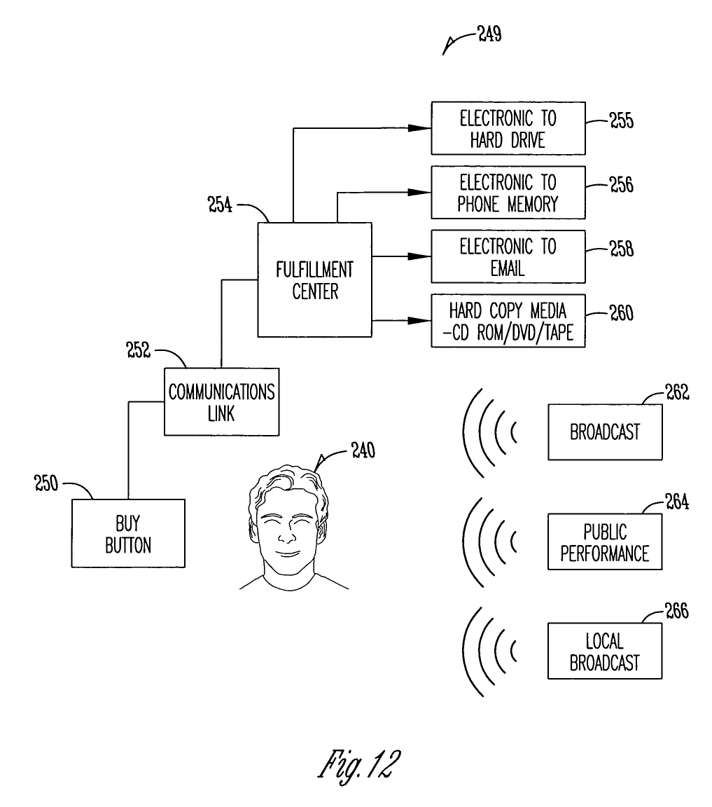

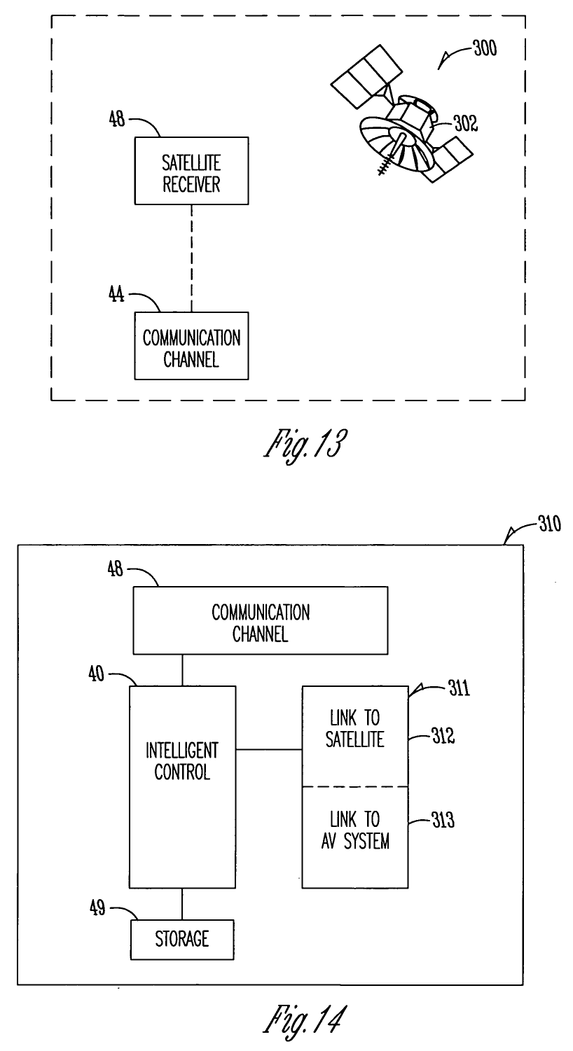

FIG. 2 illustrates another type of phone, similar to the phone of FIG. 1, but with an open, as opposed to closed, positioning capability. The first body 222 is hinged to the second body 224 through a hinge 220. As shown in FIG. 2, the phone includes a first body 222 and a second body 224. There is also a second display 226 shown. The present invention is not limited to the particular configuration of phone shown. The present invention contemplates numerous variations in the type of phone, including its physical configuration.

FIG. 3 illustrates the phone of FIGS. 1-2 with a screen 230 on the display that allows the user to select the source of audio that the user wishes to purchase an audio recording of and the user's delivery preference. The combination of the buttons and the screen form one embodiment of a user interface. The user can select the source of audio or video encountered from the drop-down list box 232 and a delivery preference from the drop-down list box 234. The present invention contemplates any number of sources of audio can be used. These include sources of audio directly associated with the phone, such as an FM radio built-into the phone. The sources of audio that can be used also include sources of audio for which the phone receives identifying information. For example, as will later be discussed, the phone can receive identifying information for audio associated with public performances, local broadcasts, satellite broadcasts, other types of audio, or digital video. The identifying information can be communicated to the phone through short range transmission, such as through Wi-Fi, BLUETOOTH or UWB.

In addition to specifying the particular source for the recording that the user wishes to purchase, the user can also select one of a number of delivery preferences. The delivery preferences are discussed herein in more detail, but can include download to a hard drive MP3 downloads, digital media such as CDs, DVDs, or audio cassettes, or other types of analog media. The present invention is not limited to a particular manner of delivery.

FIG. 3 also illustrates a “Confirm” button 236 which can be used to confirm a purchase. The present invention contemplates that pressing the buy button 20 once again can have the same effect as selecting “confirm.”

FIG. 4 illustrates a block diagram according to one embodiment of the present invention. In FIG. 4, a device 76 for producing audio or video is disclosed. The device 76 includes an audio source 78, a speaker 84, and a transmitter 64. The transmitter 64 transmits identifying information for the audio source 78 or identifying information for the audio being played by the audio source 78. Such a device can be used in any number of environments. For example, such a device can be present at amusement parks, or historical areas, or other places of interest. In such a use, the audio source can play an appropriate recording that may be of interest to a user. The transmission of identifying information allows a user to receive that information and then purchase a recording of the audio being played. Thus, it should be clear that the present invention contemplates use with any number of types of audio source.

In FIG. 4, a purchasing device 11 is also shown. The purchasing device 11 can be a phone. The purchasing device 11 includes an intelligent control 40. The intelligent control 40 is operatively connected to a buy button 20, a receiver 44, a display, and a communication channel 48. The receiver 44 receives identifying information from the transmitter 64 about an audio event. If a user desires to buy a recording of the audio event, the user can initiate a transaction with the buy button 20 to purchase an audio recording. The purchase can be transacted by sending appropriate information over the communication channel 48.

In FIG. 5, a satellite radio interface 10 is shown. The satellite radio 10 is preferably capable of receiving XM or SIRIUS transmissions. The satellite radio 10 includes a display 12, a plurality of radio controls such as radio control buttons 14 which can define preset channels and radio controls 16 and 18 which control channel and volume, respectively. The present invention contemplates that numerous other types or variations of radio controls can be used. The present invention provides for communication between the satellite radio 10 with the phone 200. Thus, a user can select the satellite radio as an audio source and thereby purchase audio events being played by the satellite radio. In such an embodiment, the satellite radio 10 communicates identifying information for the radio event to the phone 200. In this embodiment of FIG. 5, communication between the phone 200 and the satellite radio 10 is wireless and preferably through a short range transmission such as through BLUETOOTH, UWB, WiMax.

FIG. 6 illustrates an embodiment of the invention similar to that shown in FIG. 5. In FIG. 6, however, the satellite radio 10 includes a buy button 20, but does not include its own two-way communication channel. In such an embodiment, the satellite radio 10 can be operatively connected to a phone 30 having a display 32 and a keypad 34 via a wired connection. In such an embodiment, the present invention provides for proper interaction between the satellite radio and the phone for communicating purchase information from the satellite radio 10, using the phone 30.

In FIG. 6, there is a buy button 20. The buy button 20 is conveniently placed as a part of the satellite radio 10. Thus, a listener of the radio can simply press the BUY button 20 to purchase a recording of a currently playing audio event. A telephone 30 with display 32 and keypad 34 is shown operatively connected to the satellite radio 10. The present invention contemplates that the purchase request can be transmitted over cellular or satellite network. When a request is made, audio event identifying information such as channel or station as well as buyer identifying information is transmitted over the network so that the purchase can be made. The present invention also contemplates that the purchaser may also need to verify the purchase through entering a code on the satellite radio or the phone 30 at the time of the purchase or may otherwise need to verify the purchase prior to purchase and delivery. Although a satellite radio and cellular telephone are shown, the present invention contemplates that other types of radios and other types of communications channels can be used. A satellite radio is preferred for a number of reasons. First, a satellite radio is a part of a large a network as opposed to independent ratio stations. This simplifies the process of resolving purchase requests. For example, only a time (in some instances a time and location) and channel information is needed in order to determine the audio event associated with that particular time. Although the present invention contemplates other types of transmissions, such as FM radio transmissions, satellite radio presently provides an ideal platform for the present invention.

FIG. 7 provides a block diagram of one embodiment of the present invention. In FIG. 7, a satellite radio 10 is shown. The satellite radio 10 includes an intelligent control 40. The intelligent control 40 can include a processor, microcontroller, microprocessor, integrated circuit, or other type of intelligent control. Operatively connected to the intelligent control 40 is a display 12 and a satellite receiver 48 for receiving satellite radio signals. The satellite radio includes radio controls 50 which can be used for defining channel presets, changing volume, changing channels, and otherwise controlling radio functions. The buy button 20 is also operatively connected to the intelligent control 40. The buy button 20 is considered to be a part of a user interface for purchasing a recording of an audio event. The present invention contemplates that instead of using buy button 20, the user interface can provide for receipt of voice commands to purchase a recording of an audio event or other types of user interface can be used.

A communications interface 42 is also electrically connected to the intelligent control 40. The communication interface 42 allows a communications channel 44 to be established. The communications interface 42 allows the intelligent control 40 to communicate over a communications channel 44 with a service that provides administration for purchase requests. The communications channel 44 can be a satellite link or a cellular communications channel or can be another type of communications channel, such as a SMS protocol channel that allows for the sending and receiving of short text messages. The communications channel may also be a communications channel that is associated with a motor vehicle, such as ONSTAR. It is preferred that the communications channel be bidirectional so that verification of receipt of purchase requests can be given or optionally, addition information can be requested. The type of communications channel used is in no way limited to the specific types of communication channels described herein as one skilled in the art will appreciate that a number of different types of communications channels can be used and the decision of which type of communication channels to use may be made based on a particular implementation of the present invention in a particular environment. Preset information regarding financial information of the purchaser may be stored and verified through confirmation pass codes stored with the satellite or cellular user contract.

An optional GPS receiver 46 is also operatively connected to the intelligent control 40. When present, the GPS receiver 46 provides accurate time and location information. Time and or location information from the GPS receiver can accompany a purchase request to help identify a requested audio event along with channel identifying information. The present invention also contemplates that where satellite radio is used, the satellite radio transmissions includes identifying information for the audio event and that this identifying information can accompany a purchase request.

A storage device 49 is also operatively connected to the intelligent control 40. The storage device 49 is preferably a magnetic or solid state memory, such as a hard drive or a FLASH drive. The present invention, however, is not limited to the particular type of memory or storage device used. One of the advantages of having a storage device 49 is that music can be downloaded directly to the storage device 49 for future enjoyment. When music is ordered, a preference can be set to directly download the music to a storage device 49 associated within the vehicle so that the music will always be available to the driver of the vehicle.

FIG. 8 illustrates another embodiment of the present invention. In FIG. 4, a device 62 has a housing 62 that houses both a satellite radio and a voice communications transceiver. In FIG. 8, the device includes a display 12 with radio controls 14 and a buy button 20. A telephone keypad 60 is also shown. Alternatively, the voice communications transceiver, instead of being integrated with the satellite radio, can be interfaced to the satellite radio through a cable or operatively connected through BLUETOOTH, UWB, infrared, or other types of short range wireless transceivers.

FIG. 9 illustrates another embodiment of the present invention. In FIG. 9, a device 80 includes a satellite radio 86, a short range transceiver 82, and an optional local determination unit 84. The short range transceiver can be a BLUETOOTH transceiver, a UWB transceiver, or other type of short range transceiver. The optional location determination unit 84 can be a GPS unit or other type of location device. The short range transceiver 82 is in operative communication with a short range transceiver 72 associated with a communications device 70. The communications device 70 also includes a voice transceiver 74. Preferably the communications device 70 is a phone or smart phone, but the present invention contemplates that other types of communications devices can be used. The link between the short range transceiver 72 of the communication device 70 and the short range transceiver 82 of the device 70 allows purchasing requests and purchase verification information concerning audio events played by the satellite radio 86 to be communicated over a communications channels such as that provided by voice transceiver 74.

The present invention contemplates that the devices 80 can be housed within a vehicle, including being housed within a dashboard of a car. The device 80 can also include a storage device 85. The storage device 85 is a memory such as a magnetic memory, a hard drive, a flash drive, or an optical drive. The present invention contemplates that works such as songs can be stored directly on the storage device 85 so that a listener can order a selection being played on their satellite radio 86 and have the selection delivered to the storage device 85.

FIG. 10 provides an overview of one embodiment of the system of the present invention. In FIG. 10 a system 100 is shown. A motor vehicle 102 includes a satellite radio 104. A communications channel interface 106 is operatively connected to the satellite radio 104. A purchase request is made over the communications channel to a communications network 108. Optionally the communications network can send verification requests or options requests to the communication channel interface 106. The communications network 108 is also operatively connected with a purchasing agent 110 which can include computers, software, and combinations of computers and software. The purchasing agent 110 can access a database of audio events 112. Thus, when given proper identifying information about an audio event—such as the identifying information included in a purchase request, the purchasing agent can determine additional information about the audio event.

A user interface for review of selections 114 is optionally provided. The present invention contemplates that instead of buying a selection immediately, the user can instead place the information concerning a particular audio event into a shopping cart or otherwise flag the audio event for potential purchase. The user can then later review these selections to determine if the user wishes to purchase the particular selections. Once a user selects the audio events to purchases, a fulfillment agent 116 which may be automated in whole or in part provides for fulfillment of the purchases. The present invention contemplates that the audio events can be recorded onto digital media such as a CD or DVD 118 (or other digital media). Alternatively, the audio events can be made available to a user as downloads 120 or can be sent as attachments to an email 122 that is sent to the user or other recipient.

FIG. 11 illustrates one embodiment of a user interface for review of selections. The present invention contemplates that a user can review the selections they have made prior to purchase or set other purchasing options. These selection options can be accessed in any number of ways, including being reviewed online on a web page or a wireless web page. These selection options can include credit card or account information as well as information about each audio event that has been selected. Examples of the type of audio event information can include a category of music 154, a name 156 of a song, the name of an artist 158, the channel 160 on which the song was played, and a time 162 that the song was played or the time the song was selected. In addition, a price 164 for a recording of the music event can also be displayed.

The user can also make selections regarding how the recordings of the music events should be delivered. For example, the present invention contemplates that the user can have each song delivered on a separate piece of digital media. Alternatively, the user can group one or more selections on a piece of digital media such as a CD or DVD by selection option 166. Alternatively, the user can have one or more selections delivered via email by selecting option 168. The present invention also contemplates that the selections can be automatically download to a memory, such as a hard drive associated with a computer or a phone, or a satellite receiver by selecting a send as download to hard drive option 169. Then the user can finalize the order by selecting the order button 170.

The present invention contemplates that the user can preset these selections so that the user need not review this information. The user can, for example, set preferences such that every time a buy button is pressed the audio event is delivered as a CD or DVD or delivered as an MP3 to email. The present invention is flexible in this regard and contemplates numerous variations that would accommodate the preferences of a particular user.

It is preferred, that when the purchasing device is phone, that there be simple presets within the phone so that one need not even review any information after initiating a purchase. Instead, the purchase automatically occurs, and delivery is made, according to the user's presets.

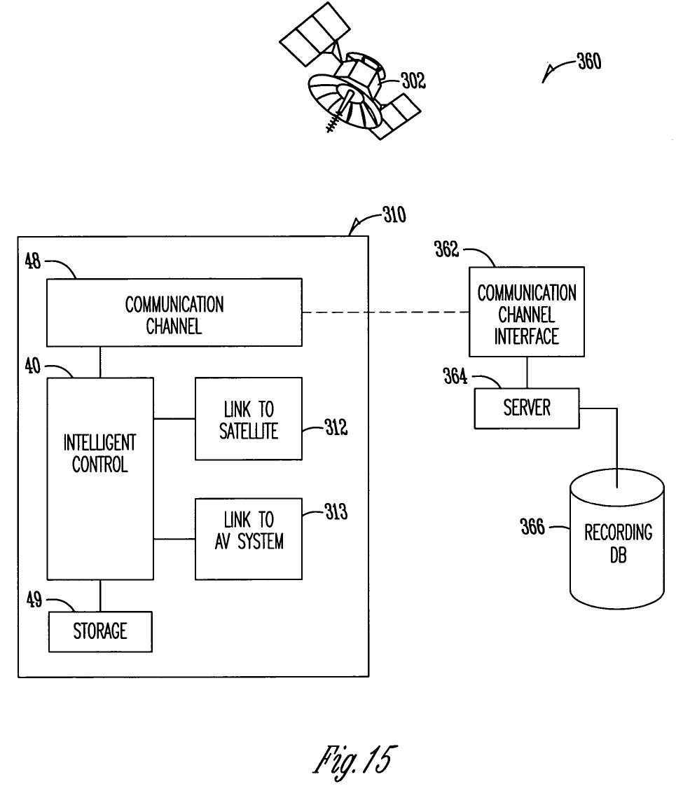

FIG. 12 illustrates another embodiment of a system 249 of the present invention. In FIG. 12, a user 240 is shown. The user 240 is in proximity to one or more audio sources. The audio sources produce audio of interest to the user 240. The user indicates their desire to purchase a recording of an audio event. The identifying information for the audio event and delivery information is then transmitted trough a communications link 252 to a fulfillment center 254. The fulfillment center then provides for delivery according to the user's preferences. The present invention contemplates that delivery can be performed in any number of ways. For example, the delivery can be electronic delivery to phone memory 256, electronic delivery to an email account associated with the user, or physical delivery of a hard copy media, such as, but not limited to a CD-ROM, DVD, or tape. The electronic delivery can also be electronic delivery to a storage device 255, such as a hard drive, associated with a vehicle.

As indicated in FIG. 12, the present invention is not limited to any particular type of audio source. For example, the audio source can be a broadcast 262, such as associated with a radio or video broadcast. Alternatively, the audio source can be a public performance 264. For example, a user can request an audio recording of an audio track for a song at a movie or concert. Alternatively, the audio source can be a local broadcast 266 such as may be confined to a local vicinity, such as music playing at an amusement park, or in a historical district that a user finds of interest.

One skilled in the art will appreciate that the present invention provides benefits and advantages beyond those that most directly affect a user of the system. For example, each purchase (or selection for potential purchase) of a music event is directly tied to a channel and a time. Therefore, recording each request and each purchase provides valuable data for the purchasing agent. This data can be used to determine relationships between time of day and purchasing, particular channels and purchasing, and particular music events, and purchasing. This data can then be used to determine which music (or other audio event) to play at what time in order to increase purchases of that music. Also, this data can provide some insight into which music is not of particular interest and which music is. Thus, each purchase request can be recorded for later data analysis. This data analysis can be used to recommend particular artists, songs, performances, videos, channels, or other products or services of potential interests to the user. Therefore, the user or purchases of a recording of an audio event will not be the only one who can benefit from the present invention.

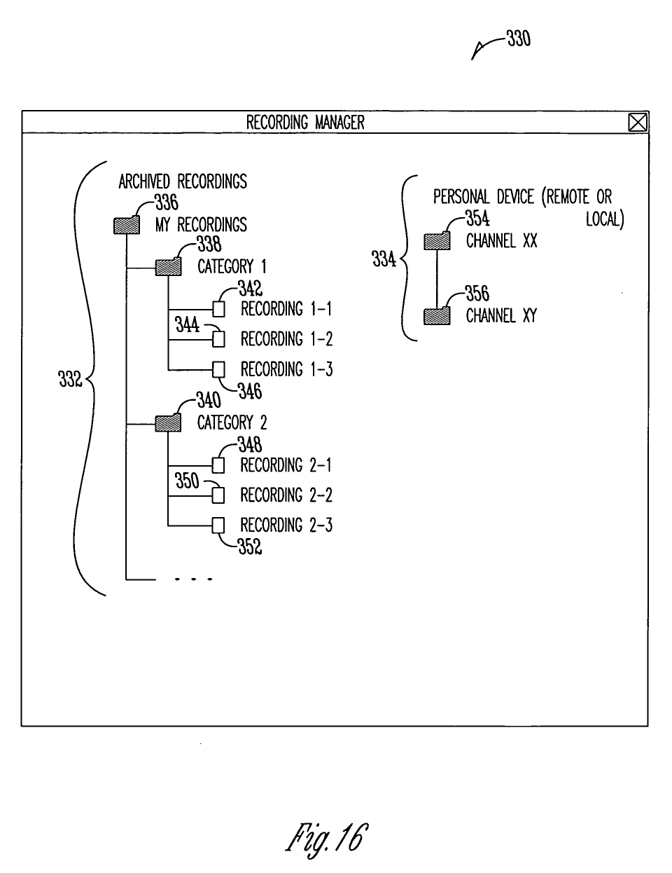

FIG. 13 illustrates communications in a satellite system 300. In FIG. 13, a satellite system including at least one satellite 302 is in communication with a satellite receiver 48. The present invention contemplates that the satellite 302 can be adapted for communication of different types of information, including audio and/or video transmissions. A communications channel 44 is operatively connected to the satellite receiver 48.

FIG. 14 illustrates one embodiment of a system 310 of the present invention. In FIG. 14, a communication channel 44 is shown. The communication channel 44 is operatively connected to an intelligent control 40. The intelligent control is operatively connected to storage 49. The storage 49 can be a hard drive, a solid state memory, a magnetic memory, or other type of storage device. The intelligent control 40 is also operatively connected to an interface system 311. The interface system 311 includes a link to satellite 312 and a link to an audio or audio-visual system 313. The communication channel 44 can be a cellular communication channel. The link to satellite 312 can be a link to a satellite receiver. The link to AV system 313 can be a link to a vehicle entertainment system.

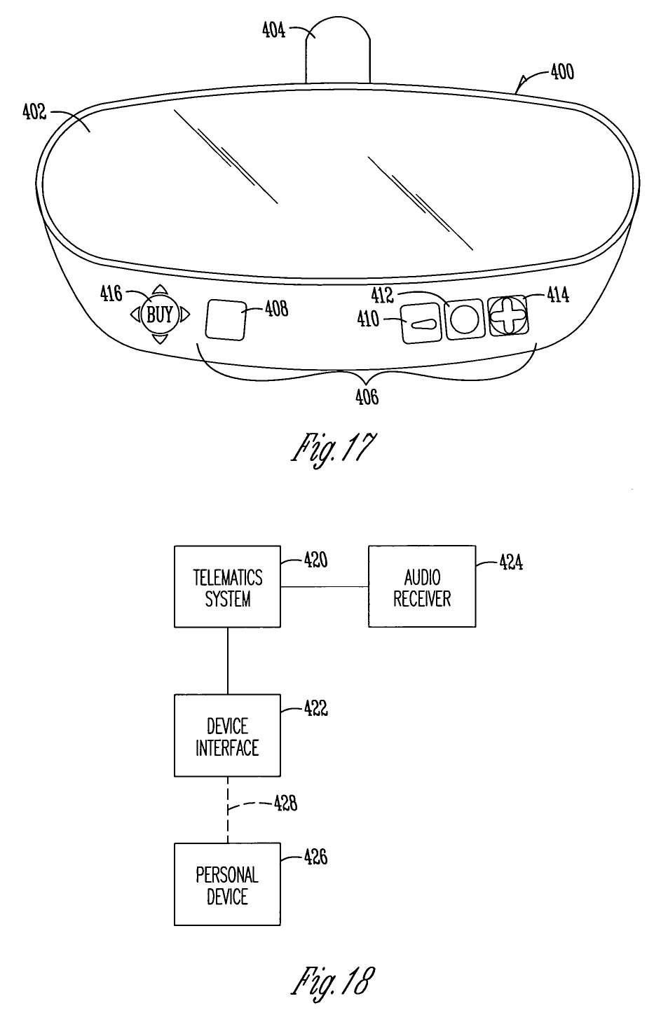

FIG. 15 illustrates another embodiment of a system 360 of the present invention. In FIG. 15, a satellite 302 is shown. There is a link 312 to the satellite 302. The link 312 may be a link to a satellite receiver. The link 312 is operatively connected to an intelligent control 40 which may be a computer, processor, microcontroller, or other type of intelligent control. The intelligent control 40 is also operatively connected to an audio-visual system 313 which may include speakers and/or a video display. The AV system may be of a kind typically associated with a vehicle such as a car or a plane. Alternatively, the AV system may be of a type associated with a home entertainment system. The AV system may include one or more speakers, video displays, and related equipment. The communication channel 48 is in operative communication with a communication channel interface 362. The communication channel 48 is preferably a wireless communication channel such as that associated with a cellular phone, however, the communication channel 48 may be of other types. The communication channel interface 362 is operatively connected to a server 364 which is operatively connected to a recording database 366. Thus, for example, a user can access a satellite radio or satellite television system. If the user finds a transmission of interest, the user can request that the transmission be purchased as a recording and in then the recording can be delivered from the recording database 366 or other location to the user. The recording can be delivered electronically to the communication channel 48, electronically through other means (such as over a high-speed Internet connection), delivered on a physical storage medium such as a CD, DVD, solid state memory, or otherwise.

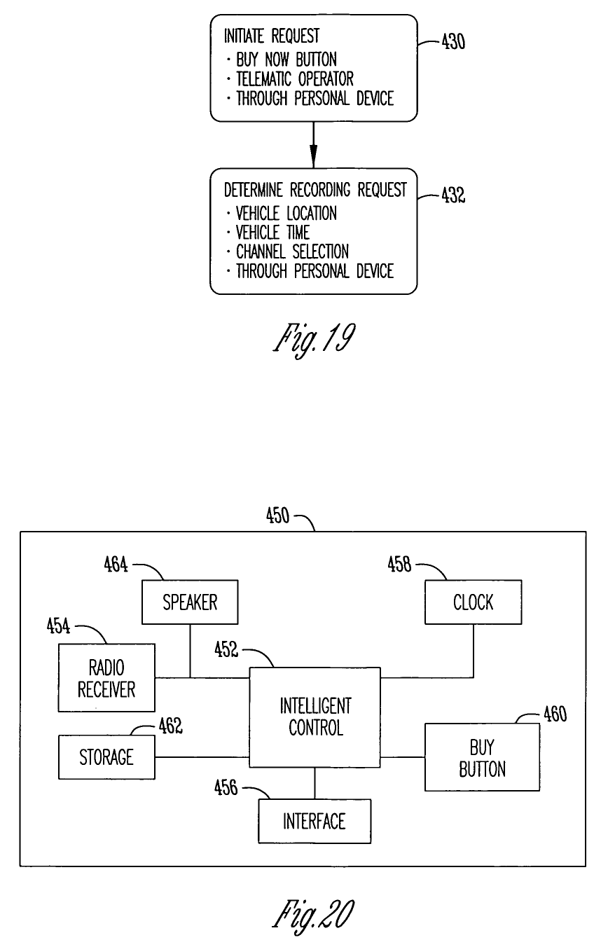

FIG. 16 illustrates a representation of a screen display 330 according to one embodiment of the present invention. In FIG. 16, a recording manager software is executed on a computing device. The recording manager allows one to store and organize recordings. The recordings can be audio recordings, video recordings, or other types of recordings. As shown in FIG. 16, recordings can be organized into archived recordings 332 through the use of file folders or another filing or organization system. “MY RECORDINGS” 336 is shown has a file holder which includes a “CATEGORY 1” 338 and a “CATEGORY 2” 340 sub folders. Within “CATEGORY 1” subfolder 338 are recordings 342, 344, 346. Within “CATEGORY 2” subfolder 340 and recordings 348, 350, and 352. Note that the screen display 330 also provides for organizing recordings which have been marked for purchase but have not yet been purchased or recordings that have been purchased. For example, recordings 334 can be associated with transmissions heard over a satellite radio system or a satellite televisions system. One way of organizing these transmissions is to have a separate folder for each channel or station. For example, a first folder 354 is associated with a first channel and a second folder 356 is associated with a second channel. This allows one to keep recordings organized. For example, if the recordings are songs, then the user may already associate one of the channels with blues music and another channel with jazz music. Organizing music recordings based on the channels where the music was first heard provides a convenient method for organization.

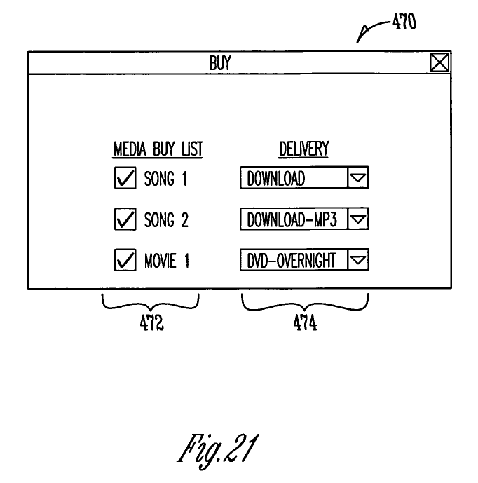

FIG. 17 illustrates another embodiment of the present invention adapted for use in a vehicle. In FIG. 17, rear view mirror 400 hangs from support structure 404. The rear view mirror has a mirror surface 402 and a user interface panel. The user interface panel includes conventional manual inputs 406 as may be associated with an ONSTAR system or other vehicle navigation system, including buttons 408, 410, 412, and 414. In addition, there is a buy button 416. The buy button 416 allows a user to purchase a product or service. The buy button 416 is preferably adapted to communicate over a communication system associated with ONSTAR or other vehicle safety and security system or telematics system.

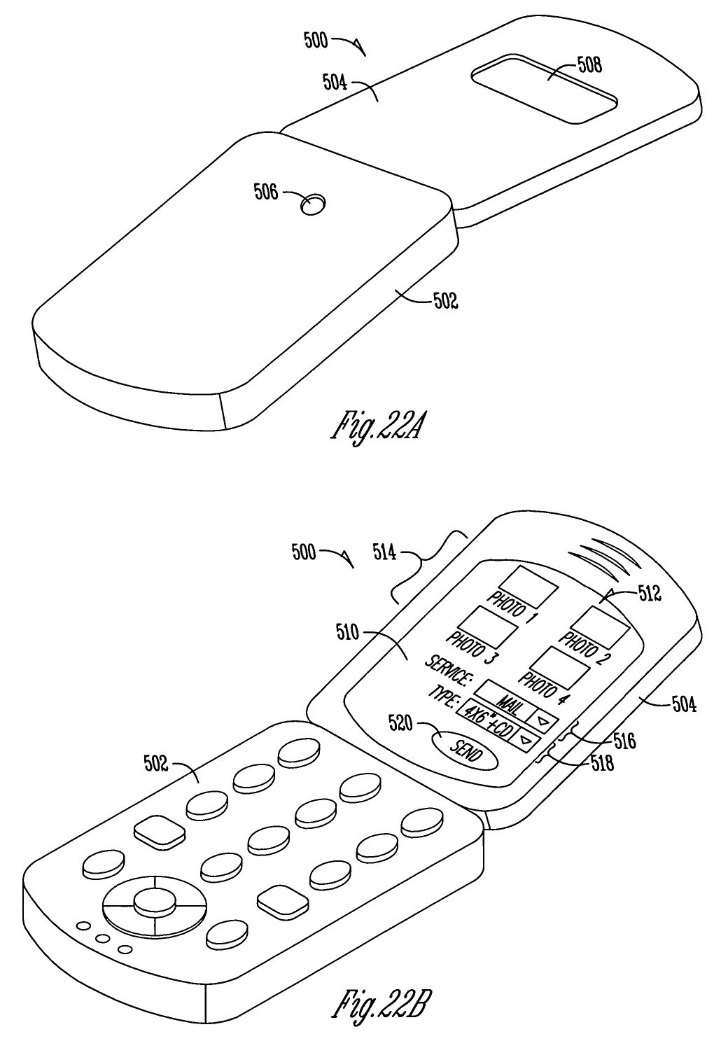

As shown in FIG. 18, a telematics system 420, such as associated with the manual inputs 406 of FIG. 17, is operatively connected to an audio receiver 424, such as a satellite radio receiver. Preferably, the audio receiver 424 is a satellite radio receiver that can communicate channel information to the telematics system 420. A device interface 422 is operatively connected to the telematics system 420 and a personal device 426 via a connection 428. The connection 428 may be a wireless connection. Thus, for example, a user can plug (or otherwise connect) a portable MP3 player device or phone into their vehicle's telematics system 420. The user can use the telematics system 420 to communicate purchase decisions over the telematics system 420. Where the services are audio and/or video recordings, the services can be delivered to the personal device 426. The present invention contemplates other types of services may also be communicated.

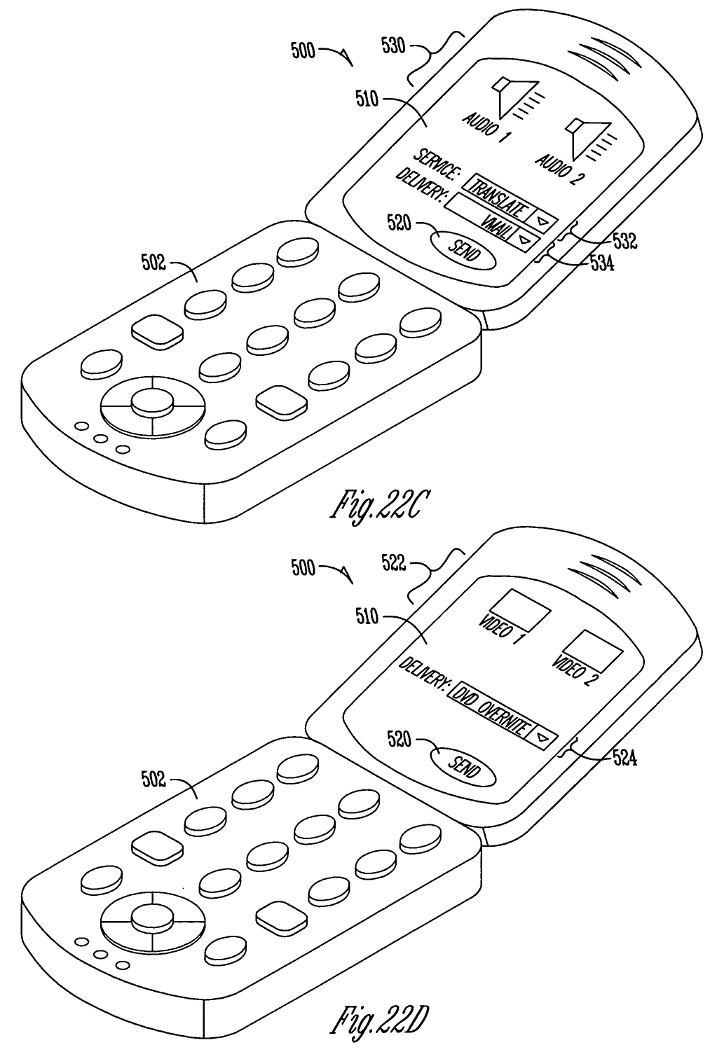

FIG. 19 illustrates one embodiment of the methodology of a system such as that presented in FIGS. 17 and 18 or variations on such a system. In step 430, a request is initiated to make a purchase. Preferably the request is initiated through use of the buy now button of a telematic system. Alternatively, the request can be initiated through a request to a telematic operator or through a personal device operatively connected to a telematic system. As shown in step 432, where the request is for a recording, a determination is made as to information necessary to identify the request. The request can include vehicle, location, vehicle time, channel selection, and whether the request is through a personal device. For example, if the request is a request for a recording of a song being played over a satellite radio and the request is made during the song, then knowing the channel selection is sufficient information to identify the song. If the request is associated with a FM radio, then knowledge of time and channel is enough information to identify information. The present invention further contemplates that the request can be made in response to a radio advertisement for a product. Or the request can be made in response to a billboard advertisement for a product in which case vehicle location would be required to identify the request. Where more than one possible request exists for a location, the user can be prompted contemporaneously or after the fact for to select from a list of potential selections. Where the request is made through a personal device, the communications channel associated with the personal device can be used, but the personal device can access channel information, location information, or other information from the radio receiver and telematics system.

FIG. 20 illustrates one embodiment of a system 450 of the present invention. In FIG. 20, an intelligent control 452 is operatively connected to an interface 456. A buy button 460 is operatively connected to the intelligent control. A clock 458 is operatively connected to the intelligent control. A storage device 462 is operatively connected to the intelligent control 452. A radio receiver 454 is operatively connected to the intelligent control and a speaker 464 is operatively connected to one or more of the radio receiver 454 and the intelligent control 452. The system 450 is one embodiment of a system that can be used within a vehicle. The interface 456 is a communications interface which can be implemented through cellular communications, through a communications channel of a separate personal device, through a telematics communication channel or otherwise.

FIG. 21 is one embodiment of a screen display 470 which can be displayed on a personal device such as a phone. The screen display 470 provides a media buy list that allows a user to select one or more media purchases based on recent requests. A user can check or un-check various selections. In addition, the user can specify the manner of the delivery through options 474. The purchases can be delivered via download to one or more different file formats or the purchases can be placed on physical media and delivered. The present invention contemplates numerous variations in the type of delivery options which may, in part, be based on the type of purchase.

The present invention provides for a personal device such as a cell phone to be used for other types of purchases as well. FIGS. 22A through 22D illustrate a cell phone 500 adapted for different types of products or services. As shown in FIG. 22A, phone 500 has a first body 502 and a second body 504 which are operatively connected. There a display 508 on the outside of the cell phone 500. In addition, a video camera 506 for taking still shots or video is incorporated into the phone 500. In FIG. 22B, a second screen 510 is shown with a screen display 512. The screen display 512 shows a set of photos 514 which have been taken with the phone 500. The software allows a user to select a service 516 associated with the photos, delivery options 518, if appropriate, and a selection 520 to initiate purchase. Upon purchase, photos stored on the phone are communicated over a cellular network for processing. This is highly advantageous to a user because it allows a user to have their photos physically delivered or available for pick up on CD, or in prints of one or more sizes.

FIG. 22C illustrates another embodiment of the present invention. On the display 510 of the phone 500 are audio selections 530 such as those recorded with a voice recorder associated with the cell phone. The service options 532 include merely storage of the voice recordings, translation of the voice recording, or other types of service. The delivery options 534 include via voicemail or phone call or email if translation service is desired, via CD or DVD if a physical service is desired.

FIG. 22D illustrates another embodiment of the present invention. As shown in FIG. 22S, different video selections 533 are available. The service or deliver options 524 include delivery on a DVD, Video-CD, download, email or other types of options.

Therefore, a system and method for purchasing of audio events has been disclosed. The present invention contemplates variations in the type of audio source, the type of communications channel, the type of purchasing device, whether it be a phone, a radio, or some other the device, the manner in which verification and purchase options are provided if they are present, the types of delivery options, and other variations within the spirit and scope of the invention now claimed.

What is claimed is:

1. A method for providing a phone service to a user for purchasing a recording, comprising:
providing a phone to the user;
receiving over the phone a request to purchase a recording;
determining the recording to be purchased;
delivering the recording to the user; and
wherein the step of determining the recording to be purchased is based on at least one item from the set consisting of a satellite radio channel being listened to by the user, a satellite video channel being listed to by the user, a geographic position associated with the user, a voice recording stored on the phone, a set of images stored on the phone, a video stored on the phone.

2. The method of claim 1 wherein the phone is operatively connected to a satellite radio and the step of determining the recording to be purchased is based on a satellite radio channel being listened to by the user.

3. The method of claim 1 wherein the phone includes a camera and the step of determining the recording to be purchased is based on a set of images stored on the phone.

3. The method of claim 1 wherein the phone includes a camera and the step of determining the recording to be purchased is based on a video stored on the phone.

4. The method of claim 1 wherein the step of determining the recording to be purchased is based on a voice recording stored on the phone and includes translating the voice recording stored on the phone.

5. The method of claim 1 wherein the step of delivering is delivering the recording on a physical storage medium.

6. The method of claim 1 wherein the step of deliver is electronically delivering the recording.
